(19) United States
(12) Patent Application Publication
(10) Pub. No.: US 2012/0107085 A1
(43) Pub. Date: May 3, 2012

(54) Housing and Mass Airflow Rate Control System for a Wind Turbine

(75) Inventors: William Paul McCowan, Queenstown, MD (US); John Spence Hayes Chapman, JR., White Hall, MD (US); Donald George Myers, Forest Hill, MD (US)

(73) Assignee: Total Energy Renewable Power Systems, LLC, Annapolis, MD (US)

(21) Appl. No.: 12/915,687

(22) Filed: Oct. 29, 2010

(51) Int. Cl. F03D 3/04; F03D 11/00; F03D 7/06

(52) U.S. Cl. 415/1; 415/4.2; 415/126; 415/141

(57) ABSTRACT

The present invention provides control for airflow to a wind turbine that allows a wind turbine to operate cost effectively and efficiently in a wide range of speeds and a variety of ambient conditions. A system has a housing, a wind turbine assembly located within an interior space of the housing, and at least one moveable shutter or deflector. The wind turbine assembly includes a shaft, a plurality of air foils or turbine blades, and a plurality of spars supporting the plurality of air foils or turbine blades rotatably around the shaft. At least one movable shutter or deflector is coupled to the housing and adjustably positioned relative to the open sides of the housing to be able to move between different positions to partially or fully cover each open side depending upon the wind speed of the ambient wind.

### BACKGROUND OF THE INVENTION

1. Field of the Invention

The field the present invention relates to wind turbines and wind generated power systems.

2. Background Art

Wind has long been known as a source for energy. However, its variability in speed has made it an unreliable source and has limited the ability of conventional wind turbines to harness wind effectively as an energy generator. The variety of wind speeds that may be encountered has led to different wind turbines and systems being used which are tailored for specific wind conditions. This has made them unsuitable or inefficient for use in buildings, docks, ships, or other structures exposed to a wide range of wind speeds and a wide range of environmental conditions.

For example, some wind turbines have been developed for producing power at low to moderate wind speeds. Most low to moderate speed wind turbines are designed for hostile environments and are not lightweight. Other wind turbines are made of certain lightweight materials (e.g., aluminum, more specifically aircraft grade aluminum) to make them more responsive to light wind speeds but are not suitable for hostile environments, such as, buildings or other outdoor structures. Many of these devices are designed to fold or feather when wind speeds exceed certain levels to prevent catastrophic failure of the turbine. Other wind turbines attempt to harness high winds for power generation, but have design limitations, such as heavyweight blades or high torque, and are unable to produce efficient power generation at low to moderate wind speeds.

Overspeed controls have been used to protect wind turbines. At high wind speeds, a wind turbine can spontaneously overspeed (e.g. blades rotational speed exceeds maximum rated rotational speed) during high winds and can be difficult to control once it runs away. Because wind turbine units are built to safely operate up to a specific speed anything from mechanical damage to catastrophic failure can occur when this limit is exceeded. Therefore, limiting the revolutions per minute is a very critical aspect of the function of many wind turbines deployed in the field.

As such, wind turbines are often designed with an overspeed protection system. In case of strong wind though it is necessary to waste part of the excess energy of the wind in order to avoid damaging the wind turbine. There are two main methods to prevent overspeed conditions. The first method employs the use of aerodynamic braking to prevent the blades from actually being able to achieve increased power production under rapidly accelerating blade rotational speeds. The second method employs the use of mechanical braking to prevent the rotational speed of the blades from rising to unacceptable levels. In either method, a control system or controller is involved in monitoring a variety of measurements (e.g. wind direction, wind speed, shaft rotational speed, etc) to maintain the safe operation of a wind turbine and avoid an overspeed condition. Such braking and overspeed protection controls though introduce additional mechanical and electrical complexity in the turbine operation, increase turbine cost, require additional power, and increase maintenance costs. These protection systems are not fool proof. Braking and overspeed protection do not provide mechanisms for avoiding a catastrophic event (e.g., blade loss, generator meltdown, wind turbine structural damage or failure, and/or total wind turbine destruction).

What is needed are methods and systems that allow wind turbines to operate cost effectively and efficiently in a wide range of wind speeds and a variety of ambient conditions.

### BRIEF SUMMARY OF THE INVENTION

The present invention provides control for airflow to a wind turbine that allows a wind turbine to operate cost effectively and efficiently in a wide range of wind speeds and a variety of ambient conditions.

In one embodiment, a system has a housing, a wind turbine assembly located within an interior space of the housing, and at least one moveable shutter or deflector. The wind turbine assembly includes a shaft, a plurality of air foils or turbine blades, and a plurality of spars supporting the plurality of air foils or turbine blades rotatably around the shaft. The housing has an interior space wherein the wind turbine assembly is disposed, and a plurality of open sides surrounding the wind turbine assembly capable of receiving ambient wind. The at least one movable shutter or deflector is coupled to the housing and adjustably positioned relative to the open sides of the housing to be able to move between different positions to partially or fully cover each open side depending upon the wind speed of the ambient wind.

In another feature, the wind turbine assembly is an ultralight or lightweight turbine assembly with a hurricane-rated shutter or deflector and may still operate in ambient winds having a wide range of wind speeds including but not limited to from 2 to 120 miles per hour.

In a further feature, the at least one movable shutter or deflector is adjustably positioned relative to the open sides of the housing such that the areas of the open sides that are partially covered by the at least one moveable shutter or deflector vary depending upon the orientation of an open side relative to incident wind, the wind speed of the incident ambient wind, and a maximum mass air flow rate permitted through the wind turbine assembly.

In another feature and advantage, the housing is further configured for mounting on an exterior of a building, home, dock, ship, or other structure exposed to an ambient wind.

In another embodiment, a method comprises disposing a wind turbine assembly having blades in an interior space of a housing, and adjustably positioning at least one moveable shutter or deflector relative to open sides of the housing to at least partially cover the open sides depending upon the wind speed of the ambient wind.

In one embodiment, there are wind intakes positioned within the interior space in each side of the housing configured to direct ambient wind at an angle α into the wind turbine assembly. Each wind intake is comprise of one or more wind ramps. In one embodiment, at least one of the wind ramps is hinged so that it is rotateably useable as a wind dam to partially block the flow of ambient wind into the wind turbine assembly.

Further embodiments, features, and advantages of the present invention, as well as the structure and operation of the various embodiments of the present invention, are described in detail below with reference to the accompanying drawings.

It is to be understood that both the foregoing general description and the following detailed description are exemplary and explanatory only, and are not restrictive of the invention as claimed.

### BRIEF DESCRIPTION OF THE DRAWINGS/FIGURES

The accompanying figures, which are incorporated herein and form part of the specification, illustrate a housing and wind speed control system for a wind turbine assembly. Together with the description, the figures further serve to explain the principles of the housing and wind speed control systems for a wind turbine assembly described herein and thereby enable a person skilled in the pertinent art to make and use the housing and wind speed control system for a wind turbine assembly.

FIG. 1A is an exemplary wind speed control system made according to an embodiment of the present invention.

FIG. 1B is a side view of the exemplary wind speed control system shown in FIG. 1A with a movable shutter or deflector in a fully extended position.

FIG. 1C is a top plan view of the exemplary wind speed control system shown in FIG. 1A with a movable shutter or deflector in a fully extended position.

FIG. 2 is an exemplary wind turbine assembly made according to an embodiment of the present invention.

FIG. 3 is an exemplary wind speed control system made according to another embodiment of the present invention.

FIG. 4A is an exemplary wind speed control system made according to another embodiment of the present invention.

FIG. 4B is a side view of the exemplary wind speed control system shown in FIG. 3A with a movable shutter or deflector in a fully extended position.

FIG. 5 is an exemplary wind speed control system made according to another embodiment of the present invention.

FIG. 6A is top plan view of a exemplary wind speed control system similar to the one shown in FIG. 1A with a plurality of wind ramps for deflecting the wind at an optimized angle into the wind turbine.

FIG. 6B is a side view of the exemplary wind speed control system shown in FIG. 6A showing one wind intake formed by a plurality of wind ramps.

FIG. 6C is top plan view of another exemplary wind speed control system similar to the one shown in FIG. 1A and FIG. 6A with a plurality of hinged wind ramps for deflecting the wind at an optimized angle into the wind turbine when extended, and for at least partially blocking the wind from entering the wind turbine

### DETAILED DESCRIPTION OF THE INVENTION

Reference will now be made in detail to embodiments of the present invention with reference to the accompanying figures, in which like reference numerals indicate like elements.

Embodiments of the present invention relate to apparatus and methods for controlling the mass airflow rate through a wind turbine assembly to allow effective operation over a wide range of wind speeds. According to a further feature, apparatus and methods for controlling the mass airflow rate further protect the wind turbine from high wind conditions and prevent overspeed while allowing effective operation over a wide range of wind speeds.

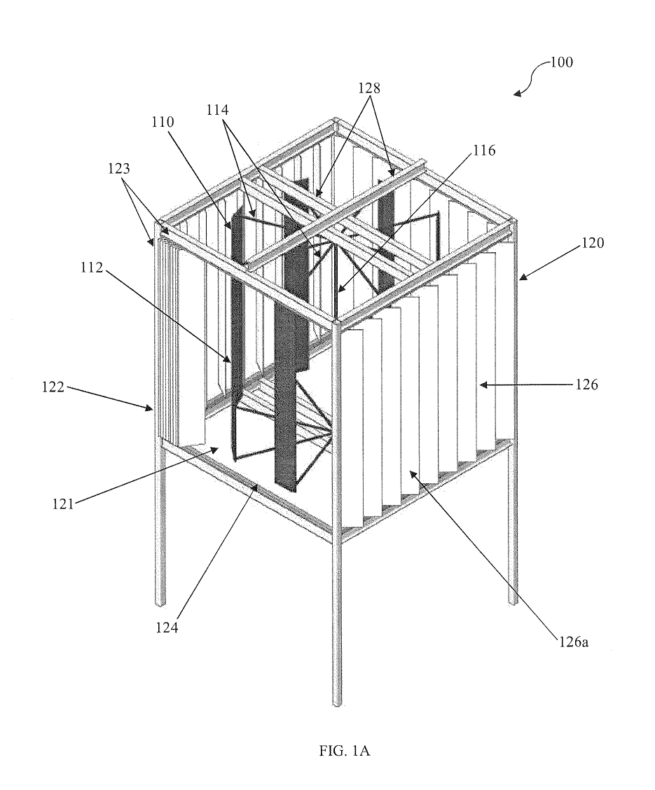

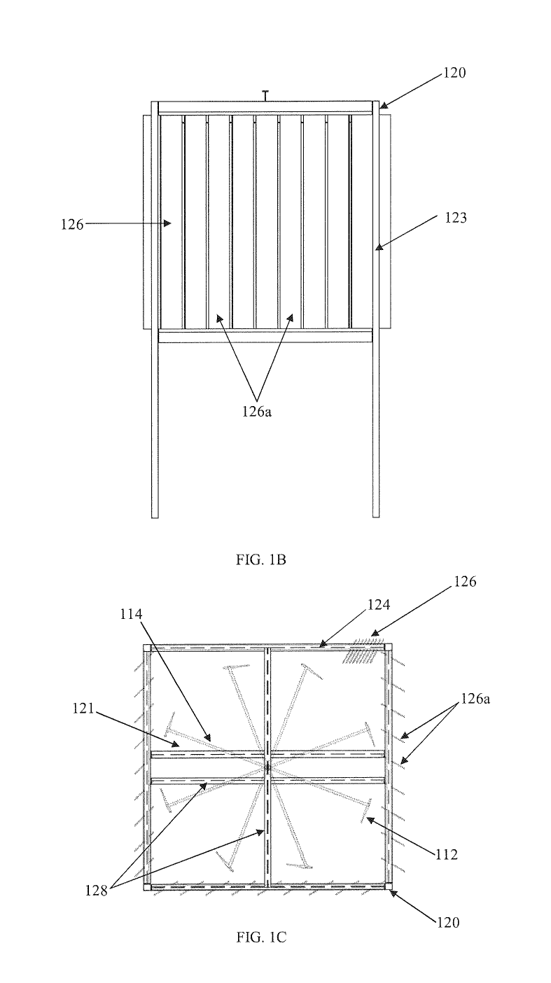

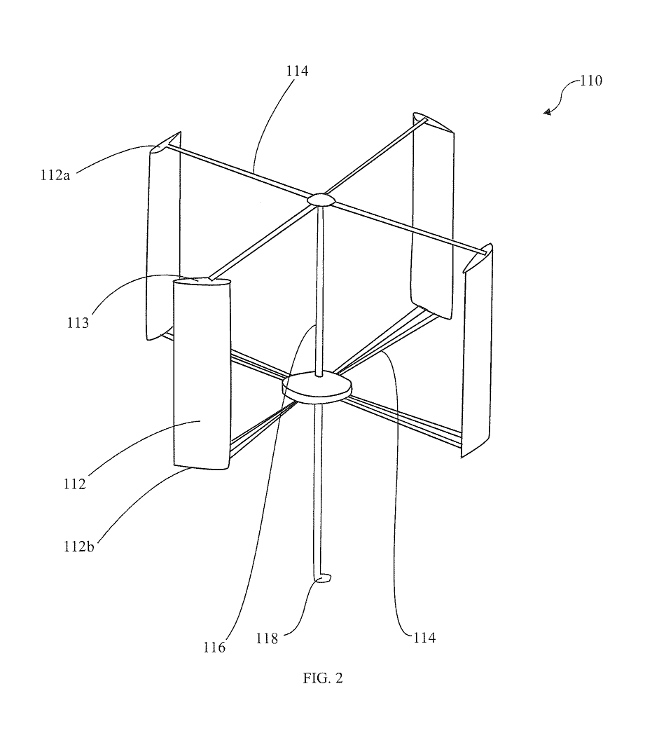

FIGS. 1A-1C are diagrams showing a system 100 in respective perspective, side, and top views (system 100 may also have a roof and a floor, not shown in the figures). System 100 includes a wind turbine assembly 110 and a housing 120. Wind turbine assembly 110 includes a plurality of airfoils 112, a plurality of spars 114, and a main shaft 116. The main shaft 116 may optionally be coupled to a gear box (not shown). A generator (not shown) can also be coupled to gear box. Housing 120 includes an interior space 121, a plurality of open sides 122 defined by edges 123, and support beams 128. Movable shutters or deflectors 126 are disposed within respective open sides 122. Wind turbine assembly 110 is attached and suspended from support beams 128 so as to be disposed within interior space 121 of housing 120. Moveable shutters or deflectors 126 are disposed within open sides 122 and are gradually movable between a retracted position, where open sides 122 are fully exposed, and a variety of extended positions wherein open sides 122 are partially covered to varying degrees to control the mass airflow rate of wind passing through wind turbine assembly 110.

As illustrated in FIG. 1A-1C, any small scale wind turbine (e.g., suitable for use with a home, farm, or building) can be easily installed in housing 120 to limit the wind turbines exposure to harsh environmental conditions (e.g., gale force winds or torrential rain) and control the mass airflow rate reaching the wind turbine assembly to prevent overspeed conditions. In non-limiting examples, wind turbine assembly 110 can be a small-scale vertical axis wind turbine and/or a small-scale horizontal axis wind turbine. Lightweight material and designs may also be used allowing wind power generation in light winds. For example, the lightweight material may be carbon fiber or plastic. Yet system 100 in this example can still operate in moderate and high winds with appropriate control of the moveable shutter or deflector to maintain an acceptable mass airflow rate through wind turbine assembly 110. Because the present invention allows winds from any direction to enter housing 120, both small-scale vertical axis and horizontal axis wind turbines can be easily installed in housing 120. This also provides additional flexibility in configuring the system for mounting on an exterior of a structure and still have the system be responsive to desired airflow from an incident ambient wind.

In one embodiment, wind turbine assembly 110 is a lightweight turbine assembly made of generally ultralight to lightweight materials including but not limited to plastic, aluminum, and composite materials.

As shown in further detail in FIG. 2, in one example, wind turbine assembly 110 can include a plurality of air foils or turbine blades 112, a plurality of spars 114, a main shaft 116, and a gear box 118. Airfoils 112 are attached to spars 114. In embodiments wherein wind turbine assembly 110 is of the vertical axis type, each air foil or turbine blade 112 can be attached to a spar 114 at a top end 112a and a bottom end 112b of air foil or turbine blade 112 via a rotational bearing 113 to allow for free rotation of air foils or turbine blades 112. Spars 114 serve as linkages to connect airfoils 112 to main shaft 116 so main shaft 116 rotates when ambient wind passes through assembly 110. In another example, the plurality of air foils or turbine blades 112, are each individually coupled to the main shaft 116 with a single spar 114, which can be attached to the air foil or turbine blade 112 anywhere along its length, for example, at the midpoint of the air foil or turbine blade 112. Main shaft 116 can be mechanically coupled to a gear box 118, which can be coupled to a generator (not shown) to produce power. In other embodiments, gear box 118 may not be necessary and main shaft 116 may be directly connected to a generator to produce power. The generator can output the electricity produced to an electrical grid, battery, storage device, or other electrical load as desired. In one feature, a hanging vertical axis design from support beam 128 allows wind turbine assembly 110 to be directly coupled to an in-line generator resulting in even greater efficiency.

In one feature, as seen in FIGS. 1A-1C, wind turbine assembly 110 is disposed within an interior space 121 of housing 120. Wind turbine assembly 110 is attached suspended from support beams 128, so the weight of the wind turbine assembly is supported from above and the system is under tension rather than compression. Main shaft 116 of wind turbine assembly 110 is connected to support beams 128 via a bearing housing to allow for free rotation of main shaft 116. Any type of bearing housing may be used including, but not limited to, ball, roller, sleeve, or needle type bearings.

In one embodiment, housing 120 is an open cube (e.g., the side surfaces are open such that edges 123 of the housing create the outline of a cube) to allow wind to enter the interior space 121 of housing 120. Housing 120 is not limited to a cube-shape structure. In other embodiments, housing 120 can be an open cylinder, a pyramid or any other suitable open 3-dimensional structure with an interior space in which wind turbine assembly 110 can be disposed that is known to one of ordinary skill in the art.

As seen in FIGS. 1A-1C, housing 120 has a plurality of open sides 122 defined by edges 123. Within each open side 122, a movable or adjustable shutter or deflector 126 is disposed. Each movable shutter or deflector 126 can be made from any material that is strong and durable to protect wind turbine assembly 110 from environmental elements and work across a wide range of wind speeds. In one example, movable shutter or deflector 126 can be a modified hurricane shutter or deflector. In other embodiments, moveable shutter or deflector 126 may be a unitary panel, curtain, or door.

In one feature, each movable shutter or deflector 126 is gradually adjustable between a retracted position and a plurality of extended positions to open or cover open sides 122 to protect wind turbine assembly 110 and control the mass airflow rate entering housing 120.

In one example, movable shutters or deflectors 126 may be gradually adjustable between a retracted position and a plurality of extended positions. The movable shutters or deflectors 126 can be moved along tracks 124 disposed within edges 123 of housing 120. When one of the movable shutter or deflector 126 is in a retracted position, as illustrated in FIG. 1A, the corresponding open side 122 is exposed to allow wind to flow into the interior space 121 of housing 120 so that the wind can cause wind turbine assembly 110 to rotate. When movable shutter or deflector 126 is in a fully extended or closed position, shutter or deflector 126 covers open side 122 so that wind cannot flow into the interior space 121 of housing 120, as illustrated in FIG. 1B. Shutter or deflector 126 is also adjustable between a variety of partially extended positions such that open side 122 is partially covered to still allow wind to flow into housing 120 (FIG. 1C). The adjustment of shutters or deflectors 126 allows for control of the mass airflow rate as the wind speed conditions change. For example, as wind speed increases and overspeed conditions can become a concern, a human operator or control system (not shown) can monitor the wind speed, the shaft rotational speed, and other parameters to accordingly adjust shutters or deflectors 126 between the retracted position and extended positions to maintain wind turbine assembly 110 under optimum operating conditions. The control system can be a computer system, an electronic system, or a manual system.

In one embodiment, as illustrated in FIGS. 1A-1C, movable shutters or deflectors 126 comprise a plurality of vertically disposed blades, wherein each of the blades are gradually movable between an extended position and a retracted position so as to control a mass airflow rate of wind entering the interior space 121 of housing 120.

In one embodiment, movable shutters or deflectors 126 may comprise a plurality of vertically disposed blades 126a that can be gradually moved along tracks 124 like a vertical blade. The vertically disposed blades 126a can also be individually pivotably adjustable so that when moveable shutter or deflector 126 is fully extended, blades 126a can be pivotably rotated to varying degrees to allow wind to flow into housing 120 or rotated fully to cover open side 122 (see different arrangements shown in FIGS. 1A-1C).

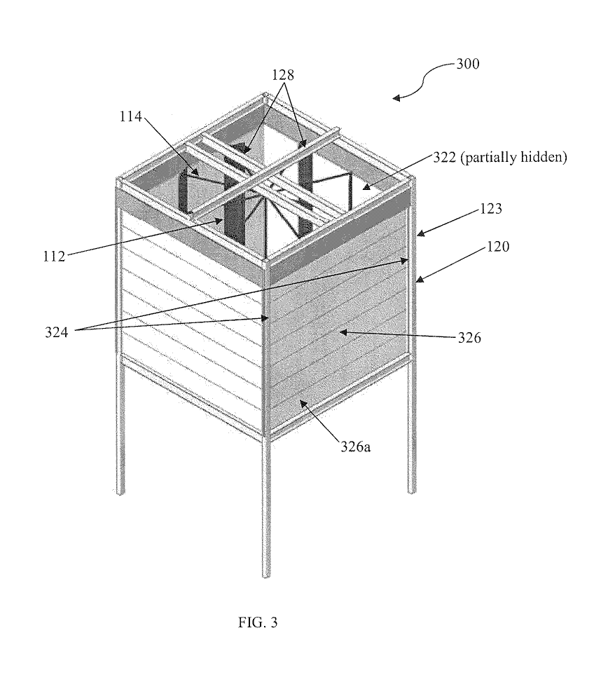

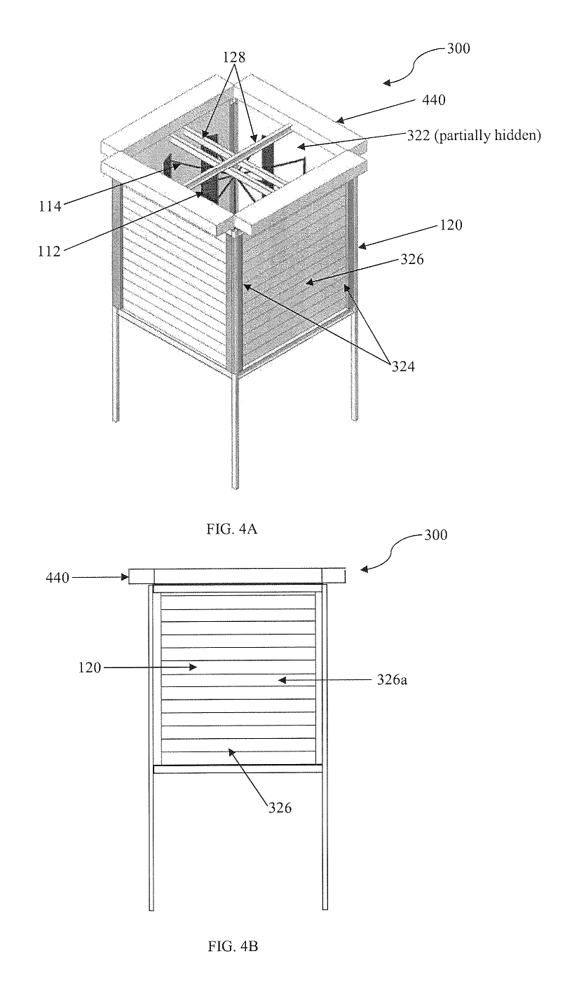

In another embodiment, as shown in FIGS. 3, 4A-4B, system 300 includes movable shutters or deflectors 326 may comprise a plurality of horizontally disposed blades 326a that are gradually adjustable along vertical tracks 324. Further, blades 326a may be individually pivotably adjustable along a horizontal axis so as to tilt like horizontal window blinds. As such, shutters or deflectors 326 can be gradually moved along tracks 324 between a retracted position exposing open sides 322 of housing 120 and different extended positions covering at least a portion of open sides 322 to varying degrees.

In some embodiments, the movable shutters or deflectors 126 or 326 may be automatically adjusted via a control system so as to control a mass airflow rate of the wind entering the interior space 121 in housing 120. The automatic adjustment control system can be a computer system, an electronic system, or a manual system. In other embodiments, the movable shutters or deflectors can have an override system and may be automatically adjusted via an override system independently of the control system. In further embodiments, the movable shutters or deflectors may be manually adjustable to control the mass flow rate of wind entering the interior space of the housing independently from the control system.

In a further feature, a solar element, such as, one or more solar panels 440 may be arranged on any side of housing 120 to generate electrical power captured from solar energy.

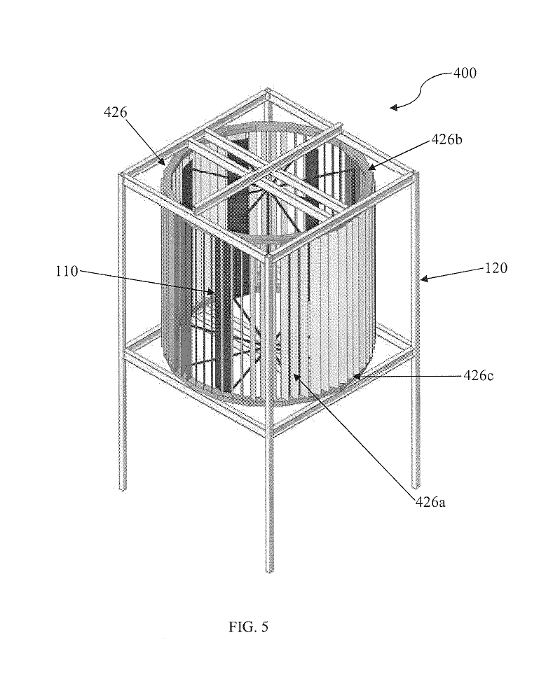

In another embodiment of the present invention, as seen in FIG. 5, a system 400 may comprise a housing 120, wind turbine assembly 110, and a movable shroud 426. Movable shroud 426 is disposed circularly around wind turbine assembly 110. Movable shroud 426 has a plurality of vertically disposed blades, wherein each of the blades are rotatably movable between an open position in which the wind turbine assembly 110 is exposed and a retracted position wherein the wind turbine assembly 110 is covered so as to control the flow of wind into the interior space of the housing. System 400 allows the mass air flow into the housing to be controlled by adjusting blades of the movable shroud 426. The movable blades or slats can be automatically adjusted via a control system so as to control a mass flow rate of air into housing 120. The automatic adjustment control system can be a computer system, an electronic system, or a manual system. In some embodiments, the movable blades or slats may be manually adjusted to control a mass flow rate of air into the housing 120.

In one feature, shroud 426 may comprise a plurality of adjustable blades or slats 426a that can also be pivotably rotated. Slats 426a are disposed between an upper edge 426b and a lower edge 426c of the shroud and be pivotably contacted to edges 426b and 426c so that slats 426a can be titled between a closed position in which wind turbine assembly 110 is covered and open positions wherein wind can flow into the interior of housing 120 and reach turbine assembly 110. In some embodiments, pivotably rotatable and moveable slats 426a can be automatically adjusted via a control system so to control the mass airflow rate. The automatic adjustment control system can be a computer system, an electronic system, or a manual system. In other embodiments, pivotably rotatable and moveable slats 426a can be manually adjusted, independently of the control system, to control the mass airflow rate of wind reaching turbine assembly 110.

In one example, shroud 426 may be made from any material that is strong and durable, such as, hurricane rated material (i.e., can withstand wind speeds in excess of 75 mph).

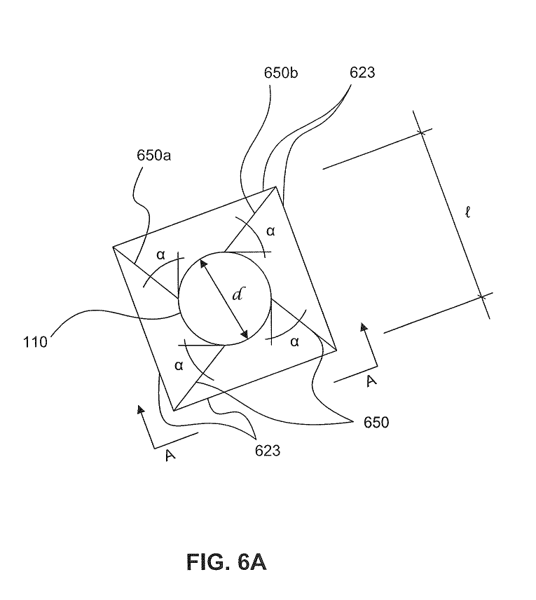

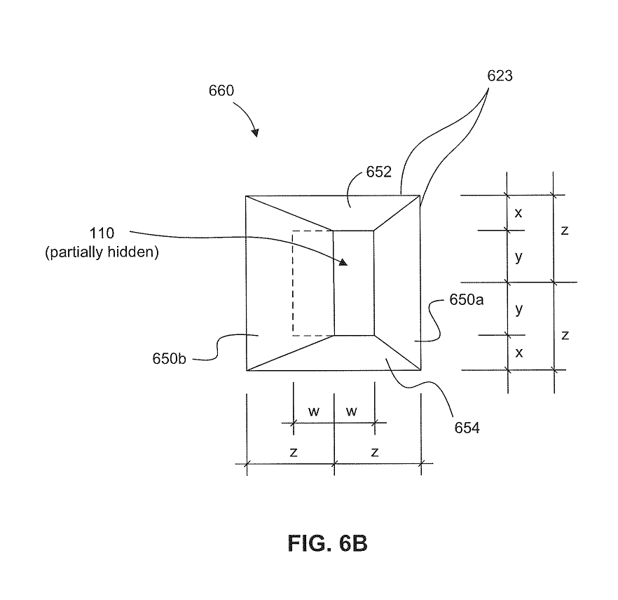

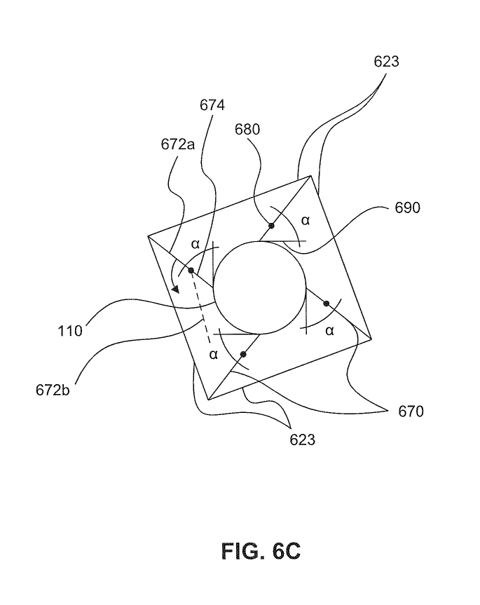

In another embodiment, the system 100 or 300 (shown in FIGS. 1A and 3, respectively), may also comprise, as shown in FIGS. 6A and 6B, edges 623, a wind turbine assembly 110, and a plurality of wind ramps 650, 652, and 654. FIG. 6A is a top view of the alternative system showing wind ramps 650, between the four corners of the box formed by edges 623 and the wind turbine assembly 110. The wind ramps 650 are each located in the interior space formed by the plurality of edges 623 and coupled between one edge 623 (a different edge 623 is coupled to each wind ramp 650) of the system 100 or 300 that is parallel to the axis of rotation of the wind turbine assembly 110 and the wind turbine assembly 110. In at least one example, the ramps 650 extend from a first edge 623 to a second edge of the box formed by edges 623, (e.g., housing 120 in FIGS. 1 and 3). By placing the wind ramps 650 in the interior space by the plurality of edges 623, the ramps 650 and wind turbine assembly 110 can be protected by an assembly such as moveable shutter or deflectors 126/326 shown in FIGS. 1 and 3, respectively. The first and second edges are perpendicular to axis of rotation of the wind turbine assembly 110. The wind ramps 650 are positioned such that the wind is directed at an angle α into the wind turbine assembly 110. Each wind ramp 650 as two sides 650a and 650b. In one example, the angle between the wind ramp side 650a is acute to the tangent of a cross-sectional circle of the wind turbine assembly 110. In one example, the edges 623 of the box are l inches in length. In one example, the box is 60 inches in length. In at least one example, the diameter d of the wind turbine assembly is (½)l, but may be any diameter smaller than l that provides sufficient wind turbine size to produce useable amounts of power. In at least one example, the diameter d of the wind turbine assembly is 30 inches. In one feature, this directing or funneling of wind into the wind turbine assembly 110 may increase efficiency of the system by encouraging a more direct or laminar flow of wind into the wind turbine. For example, the funneling of the wind by the wind ramps 650 reduce the turbulence at the wind turbine assembly 110, thereby reducing drag (caused by turbulent airflow) on the wind turbine, and increasing the efficiency of the system. In one example, the wind turbine assembly 110 turns in a single rotational direction and the wind ramps 650 are designed so that the directed wind turns the wind turbine is the single rotational direction.

FIG. 6B is a side view, from the perspective A of FIG. 6A. FIG. 6B shows a wind intake 660 that is created by the placement of wind ramps 650 in the interior space of system 100 or 300 (shown in FIGS. 1A and 3, respectively), from an open side (i.e., vertical or horizontal shutters or deflectors not shown) of these systems. By placing the wind intake 660 in the interior space of system 100 or 300, the wind intake 660 and wind turbine assembly 110 can be protected by an assembly such as moveable shutters or deflectors 126/326 shown in FIGS. 1 and 3 respectively. The intake 660 is comprised of at least two wind ramps 650 (shown here as the opposite sides 650a and 650b of two separate wind ramps 650) that direct wind into the wind turbine assembly 110 at an angle α. Optionally, two more wind ramps 652 and 654 may be placed at the top and bottom of the wind turbine assembly 110, sloped in such a way that they cover the opening above and below, respectively, the wind turbine assembly 110 to the box edge 623. The intake 660 (comprising at least two wind ramps 650, and perhaps two additional wind ramps 652 and 654) directs or funnels the wind into the wind turbine assembly 110 at a specific angle optimized for power generation efficiency. In one example, the edges 623 of the box are 2z inches in length. In one example, the box is 60 inches in length. The dimensions of the wind intake 660 are shown in FIG. 6B using variables w, x, y, and z. In at least one example, the wind intake 660 has the following dimensions: w=15 inches; x=10 inches; y=20 inches; and z=30 inches. In one feature, these dimensions allow the system 100 or 300 to be placed in a relatively small, hostile area where conventional wind turbines could not be placed. In another feature, the dimensions of the wind intake 660 improves power generation efficiency of the wind turbine assembly 110 by reducing wind turbulence entering the assembly. For example, the funneling of the wind by the wind ramps 650, 652, and/or 654 reduce the turbulence at the wind turbine assembly 110, thereby reducing drag (caused by turbulent airflow) on the wind turbine, and increasing the efficiency of the system. In one example, the wind turbine assembly 110 turns in a single rotational direction and the wind ramps 650 are designed so that the directed wind turns the wind turbine is the single rotational direction.

FIG. 6C is a top view of another alternative system showing hinged wind ramps 670 (similar in function to wind ramps 650 shown in FIG. 6A), between the four corners of the box formed by edges 623 and wind turbine assembly 110. The hinged wind ramps 670 are each located in the interior space formed by the plurality of edges 623 and coupled between one edge 623 (a different edge 623 is coupled to each hinged wind ramp 670) of the system 100 or 300 that is parallel to the axis of rotation of the wind turbine assembly 110 and the wind turbine assembly 110. In at least one example, the hinged ramps 670 extend from a first edge 623 to a second edge of the box formed by edges 623, (e.g., housing 120 in FIGS. 1 and 3). By placing the hinged wind ramps 670 in the interior space by the plurality of edges 623, the hinged ramps 670 and wind turbine assembly 110 can be protected by an assembly such as moveable shutter or deflectors 126/326 shown in FIGS. 1 and 3, respectively. The first and second edges are perpendicular to axis of rotation of wind turbine assembly 110. The hinged wind ramps 670 are positioned such that the wind is directed at an angle α into the wind turbine assembly 110. Each hinged wind ramp 670 comprises a hinge 680 separating two smaller wind ramps, rotating ramp 672a and fixed ramp 674. When extended, i.e., the angle at the hinge 680 between rotating ramp 672a and fixed ramp 674 is approximately 180°, the hinged wind ramp 670 functions identically to the previously described wind ramp 650 (see FIG. 6A). However, when rotating ramp 672a is rotated about hinge 680 (shown by arrow in FIG. 6C), then rotating ramp 672a functions as a partial dam (shown by broken line rotating ramp 672b) to partially block airflow from entering the wind turbine assembly 110. Although wind rotating ramp 672a is shown rotating counter-clockwise in FIG. 6C, there is nothing stopping rotating ramp 672a from rotating about hinge 680 in the clockwise direction. Because of the rotation arc of rotating ramp 672a, when placed in a system comprising moveable shutter or deflectors 126/326 shown in FIGS. 1 and 3, respectively, the shutter or deflectors 126/326 must be in the retracted position so that rotating ramp 672a can rotate about hinge 680. Wind ramp 674 remains fixed at an angle α into wind turbine assembly 110. In one example, a rotation stop 690 is part of the system and completely blocks the wind turbine assembly 110 from airflow when the hinged wind ramp 670 is in the fully hinged position 672b. In one example, the angle between the hinged wind ramp 670 is acute to the tangent of a cross-sectional circle of the wind turbine assembly 110. In one feature, this directing or funneling of wind into the wind turbine assembly 110 may increase efficiency of the system by encouraging a more direct or laminar flow of wind into the wind turbine. For example, the funneling of the wind by the hinged wind ramps 670 reduce the turbulence at the wind turbine assembly 110, thereby reducing drag (caused by turbulent airflow) on the wind turbine, and increasing the efficiency of the system. In one example, the wind turbine assembly 110 turns in a single rotational direction and the hinged wind ramps 670 are designed so that the directed wind turns the wind turbine in the single rotational direction.

Another embodiment of the present invention relates to a method comprising disposing a light-weight wind turbine assembly having blades in an interior space of a housing; and adjustably positioning at least one moveable shutter or deflector relative to open sides of the housing to at least partially cover the open sides depending upon the wind speed of the ambient wind. In one example, the adjustably positioning includes pivotably rotating the blades in the light-weight wind turbine assembly.

In a further feature, a throttle system may be added.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents. All patents and publications discussed herein are incorporated in their entirety by reference thereto.

What is claimed is:

1. A system, comprising:
a wind turbine assembly including:
a shaft,
a plurality of air foils, and
a plurality of spars supporting the plurality of air foils rotatably around the shaft;
a housing having an interior space wherein the wind turbine assembly is disposed within the interior space, and a plurality of open sides surrounding the wind turbine assembly capable of receiving ambient wind; and
at least one movable shutter coupled to the housing and adjustably positioned relative to the open sides of the housing to be able to move between different positions to partially or fully cover each open side depending upon the wind speed of the ambient wind.

2. The system according to claim 1, wherein said plurality of air foils are made of ultralight or light weight material.

3. The system according to claim 2, wherein the at least one movable shutter is adjustably positioned relative to the open sides of the housing such that the areas of the open sides that are partially covered by the at least one moveable shutter vary depending upon the orientation of an open side relative to incident wind, the wind speed of the incident ambient wind, and a maximum mass air flow rate permitted through the wind turbine assembly, whereby the light weight air foils of the wind turbine assembly may operate in an incident ambient wind having a wind speed ranging from 2 miles per hour to 120 miles per hour.

4. The system according to claim 1, wherein the at least one movable shutter comprises a set of curtains arranged around the wind turbine assembly.

5. The system according to claim 1, wherein the at least one movable shutter comprises a unitary curtain arranged around the wind turbine assembly.

6. The system according to claim 1, wherein the at least one movable shutter is automatically adjusted via a control system to control a mass flow rate of air into the housing.

7. The system according to claim 1, wherein the at least one movable shutter is manually adjustable to control a mass flow rate of air into the housing.

8. The system according to claim 1, wherein the at least one movable shutter comprises a plurality of vertically disposed blades, wherein each of the blades are movable between the extended position and the retracted so as to control a mass flow rate of air into the housing.

9. The system according to claim 8, wherein the vertically disposed blades are individually pivotably adjustable.

10. The system according to claim 1, wherein the at least one movable shutter comprises a plurality of horizontally disposed blades, wherein each of the blades are movable between the extended position and the retracted so as to control a mass flow rate of air through the housing.

11. The system according to claim 10, wherein the horizontally disposed blades are individually pivotably adjustable.

12. The system according to claim 1, wherein the housing further comprises at least one solar panel to generate electrical power.

13. The system according to claim 1, wherein the housing is further configured for mounting on an exterior of a building, home, dock, ship, or other structure exposed to an ambient wind.

14. The system of claim 1, wherein the wind turbine assembly comprises an ultralight or lightweight wind turbine assembly and the at least one moveable shutter is hurricane rated.

15. The system of claim 1, further comprising:
a plurality of wind intakes positioned within the interior space in each side of the housing, configured to direct the ambient wind at an angle α into the wind turbine assembly.

16. The system of claim 15, wherein the angle α is 45 degrees.

17. The system of claim 15, each wind intake further comprising:
a first and a second ramp, coupled between edges of the housing and the wind turbine assembly and extending from a first side to a second side of each side of the housing,
wherein the at least two ramps in each side of the housing partially cover the wind turbine assembly,
wherein the first and second sides are perpendicular to the axis of rotation of the wind turbine assembly, and
wherein each edge coupled to the first or second ramp is parallel to the axis of rotation of the wind turbine assembly.

18. The system of claim 17, the wind intake further comprising:
a second ramp, coupled between the first side of each side of the housing and a first end of the wind turbine assembly; and
a third ramp, coupled between the second side of each side of the housing and a second end of the wind turbine assembly.

19. The system of claim 17, each of the first and second ramps further comprising:
a fixed ramp;
a rotating ramp configured to partially impede airflow from entering the wind turbine assembly when the rotating ramp no longer approximately in a line with the fixed ramp; and
a hinge coupled between the fixed ramp and the rotating ramp configured to support the rotation of the rotating ramp.

20. A method, comprising:
disposing a wind turbine assembly having blades in an interior space of a housing; and
adjustably positioning at least one moveable shutter relative to open sides of the housing to at least partially cover the open sides depending upon the wind speed of the ambient wind.

21. The method of claim 20, wherein the adjustably positioning includes pivotably rotating the blades in the wind turbine assembly.

22. The method of claim 20, wherein the wind turbine assembly comprises an ultralight or lightweight wind turbine assembly and the at least one moveable shutter is hurricane rated.

23. The method of claim 20, further comprising:
directing the ambient wind into the wind turbine assembly at an angle α using a wind intake positioned within the interior space.

24. The method of claim 23, wherein the wind intake comprises a plurality of ramps.
